(19) United States
(12) Patent Application Publication
(10) Pub. No.: US 2024/0177925 A1
(43) Pub. Date: May 30, 2024

(54) MAGNETIC COMPONENT FOR GALVANICALLY ISOLATED LCL-T RESONANT CONVERTER

(71) Applicant: Delta Electronics, Inc., Taipei (TW)

(72) Inventors: Satyaki Mukherjee, Durham, NC (US); Peter Mantovanelli Barbosa, Durham, NC (US)

(21) Appl. No.: 17/994,943

(22) Filed: Nov. 28, 2022

(51) Int. Cl. H01F 27/34; H01F 27/30

(52) U.S. Cl. CPC H01F 27/346; H01F 27/306; H01F 2027/348

(57) ABSTRACT

A magnetic component for a galvanically isolated LCL-T resonant converter is provided. The magnetic component includes first and second cores, a primary winding and a secondary winding. The first core includes a first outer post, a second outer post, and a center post. The primary winding has primary turns including first primary turns located around the first outer post and second primary turns located around the second outer post. The secondary winding has secondary turns including first secondary turns located around the first outer post and second secondary turns located around the second outer post. The center post of the first core and the second core are separated by a first air gap. The turns distribution and the first air gap are used to control and integrate a controllable leakage inductance, where the center post is used as a leakage path.

### FIELD OF THE INVENTION

The present disclosure relates to a magnetic component for a galvanically isolated LCL-T resonant converter, and more particularly to a magnetic component for a galvanically isolated LCL-T resonant converter that integrates a controllable leakage inductance.

### BACKGROUND OF THE INVENTION

FIG. 1A shows a conventional planar magnetic design for transformers. In this pictorial representation, an E+I core segment is used, where following standard E core geometry, the outer posts and bottom plate of E core segment have half the thickness compared to the center post. Both primary and secondary windings are wound around the center post of the E core segment. Planar magnetics with PCB (printed circuit board) windings are increasingly becoming popular due to their automated manufacturing, controlled parasitic parameters, enhanced thermal performance and low profile. For example, (i) “Z. Ouyang and M. A. E. Andersen, “Overview of Planar Magnetic Technology-Fundamental Properties,” in IEEE Transactions on Power Electronics”, and (ii) “B. Li, Q. Li and F. C. Lee, “High-Frequency PCB Winding Transformer with Integrated Inductors for a Bi-Directional Resonant Converter,” in IEEE Transactions on Power Electronics”.

In FIG. 1A, it should also be noted how the primary and secondary turns are sandwiched one after the other. This phenomenon known as interleaving is extremely important for high-frequency transformers to limit AC losses in the windings. The E and I cores are separated by some airgap g. From the reluctance model of this transformer shown in FIG. 1B, it can be seen that all the fluxes generated by the primary winding has to link the secondary windings and vice versa, as there is no first order path for leakage flux to flow in this arrangement. Thus, the conventional transformers with the planar magnetic design of FIG. 1A fail to generate any controllable leakage inductance integration due to absence of any first order leakage path.

Similarly, another prior art is shown in FIG. 2A where instead of E+I cores, a U+I core is considered for high-frequency transformer construction. Here, the windings are located around the two side posts of the U core segment. This is an important distinction compared to the geometry shown in FIG. 1A. The distribution of the turns is also important to note here. To maintain the desired turns ratio of Nₚ:Nₛ, it is imperative to maintain Nₚ=Nₚ₁+Nₚ₂ and Nₛ=Nₛ₁+Nₛ₂. Nₚ is the total number of primary turns of the primary winding, and Nₛ is the total number of secondary turns of the secondary winding. The primary turns Nₚ includes first primary turns Nₚ₁ located around the first side post and second primary turns Nₚ₂ located around the second side post. The secondary turns Nₛ includes first secondary turns Nₛ₁ located around the first side post and second secondary turns Nₛ₂ located around the second side post. The most common choice which results in the optimized interleaving and minimum winding losses is

$${N}_{p 1} = {N}_{p 2} = \frac{{N}_{p}}{2} and {N}_{s 1} = {N}_{s 2} = \frac{{N}_{s}}{2} .$$

In any case, from the general reluctance model shown in FIG. 2B, it is again clear that the fluxes generated by either the primary winding or the secondary winding would most certainly link with the other windings as all the flux flows through the same path along the U core. Hence, this magnetic structure also fails to achieve any significant controllable leakage inductance integration.

Therefore, there is a need of providing a magnetic component to obviate the drawbacks encountered from the prior arts.

### SUMMARY OF THE INVENTION

It is an objective of the present disclosure to provide a magnetic component for a galvanically isolated LCL-T resonant converter that integrates a controllable leakage inductance.

In accordance with an aspect of the present disclosure, there is provided a magnetic component for a galvanically isolated LCL-T resonant converter, including a first core, a second core, a primary winding and a secondary winding. The first core includes a first outer post, a second outer post, and a center post disposed between the first and second outer posts. The primary winding has primary turns including first primary turns located around the first outer post and second primary turns located around the second outer post. The secondary winding has secondary turns including first secondary turns located around the first outer post and second secondary turns located around the second outer post. The first and second primary turns are unequal, and/or the first and second secondary turns are unequal. The center post of the first core and the second core are separated by a first air gap. The first and second primary turns, the first and second secondary turns, and the first air gap are used to control and integrate a controllable leakage inductance, wherein the center post is used as a leakage path.

### BRIEF DESCRIPTION OF THE DRAWINGS

FIG. 1A shows a conventional planar magnetic design for transformers;

FIG. 1B shows a reluctance model of the transformer of FIG. 1A;

FIG. 2A shows another conventional planar magnetic design for transformers;

FIG. 2B shows a reluctance model of the transformer of FIG. 2A;

FIG. 3A is a schematic circuit diagram illustrating a galvanically isolated LCL-T resonant converter according to an embodiment of the present disclosure;

FIG. 3B shows the envisioned integrated magnetic component combining the functionality of the leakage inductor and isolation transformer with desired primary to secondary turns ratio;

FIG. 4A is a schematic diagram illustrating a magnetic component for the galvanically isolated LCL-T resonant converter according to an embodiment of the present disclosure;

FIG. 4B shows a reluctance model of the magnetic component of FIG. 4A;

FIG. 4C is a schematic diagram showing an example of an unequal distribution of turns in the magnetic component of FIG. 4A;

FIG. 4D is a schematic perspective view illustrating the example of FIG. 4C;

FIG. 5A shows a 2D FEM simulation of the magnetic structure of FIG. 1A with fully interleaved primary and secondary windings around the center post of an E core;

FIG. 5B shows a 2D FEM simulation of the magnetic structure of FIG. 2A with the primary and second windings distributed around the outer posts of a U core;

FIG. 5C shows a 2D FEM simulation of the magnetic component of FIG. 4A with the windings distributed equally with Nₚ₁=Nₚ₂ and Nₛ₁=Nₛ₂;

FIG. 5D shows a 2D FEM simulation of the magnetic component of FIG. 4A with unequal distribution of turns around the outer posts;

FIG. 6A, FIG. 6B and FIG. 6C show the analysis process for the reluctance model in FIG. 4B;

FIG. 7A exemplifies the directions of the leakage flux and the magnetizing flux in the reluctance model in FIG. 4B;

FIG. 7B shows an Ansys simulation for the magnetic component of the present disclosure;

FIG. 8A shows the modification to the first core of the magnetic component of FIG. 4A;

FIG. 8B exemplifies a detailed geometry of the modified cores of FIG. 8A;

FIG. 9A exemplifies an actual implementation of the first and second core of the magnetic component of FIG. 8B;

FIG. 9B exemplifies an implementation of the windings in a PCB;

FIG. 10A and FIG. 10B elaborate on the primary and secondary windings arrangement respectively;

FIG. 11 exemplifies a 3D FEM simulation of the magnetic component with one example turns distribution resulting in larger core loss and lower winding loss (closer to symmetric distribution);

FIG. 12 exemplifies a 3D FEM simulation of the magnetic component using turns distribution with large asymmetry resulting in lower core loss but higher proximity effect induced winding loss;

FIG. 13 exemplifies a 3D FEM simulation of the magnetic component with optimally picked turns distribution that results in good trade-off between core and winding losses;

FIG. 14A shows a variant of the magnetic component of FIG. 4A;

FIG. 14B shows a reluctance model of the magnetic component of FIG. 14A;

FIG. 14C shows an example of making the leakage contribution from the primary winding of FIG. 14A zero; and

FIG. 15 shows another variant of the magnetic component of FIG. 4A with a tertiary winding wound around the center post of the E core.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items. While the numerical ranges and parameters set forth for the broad scope of the present invention are approximations, the numerical value reported in the specific examples set forth as accurately as possible. However, any numerical values inherently contain certain errors necessarily the standard deviation found in the respective testing measurements caused. Also, as used herein, the term “about” generally means away from a given value or a range of 10%, 5%, 1% or 0.5%. Alternatively, the word “about” means within an acceptable standard error of ordinary skill in the art-recognized average. In addition to the operation/working examples, or unless otherwise specifically stated otherwise, in all cases, all of the numerical ranges, amounts, values and percentages, such as the number for the herein disclosed materials, time duration, temperature, operating conditions, the ratio of the amount, and the like, should be understood as the word “about” decorator. Accordingly, unless otherwise indicated, the numerical parameters of the present invention and scope of the appended patent proposed is to follow changes in the desired approximations. At least, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

A planar transformer assembly architecture and optimization is disclosed herein that provides a magnetic component which combines the functionalities of a resonant inductor and a high-frequency isolation transformer. This magnetic component can be constructed using planar magnetic cores and PCB-based windings and generally find its application in high-frequency galvanically isolated DC-DC resonant power converters. Of particular interest are LCL-T immittance network based resonant converters, where the isolation transformer can have very large magnetizing inductance and zero-voltage-switching (ZVS) of the semiconductors are ensured using inductive elements in the resonant network. In some embodiments, the isolation transformer may be without any help from the magnetizing inductance of the isolation transformer.

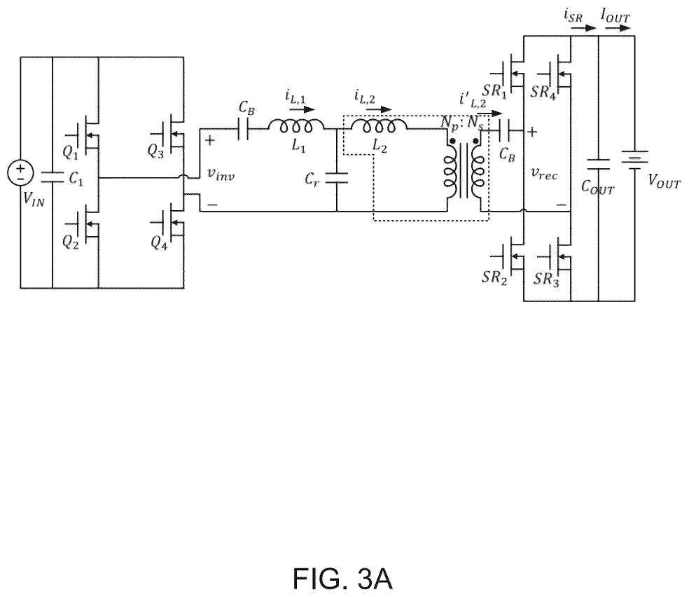

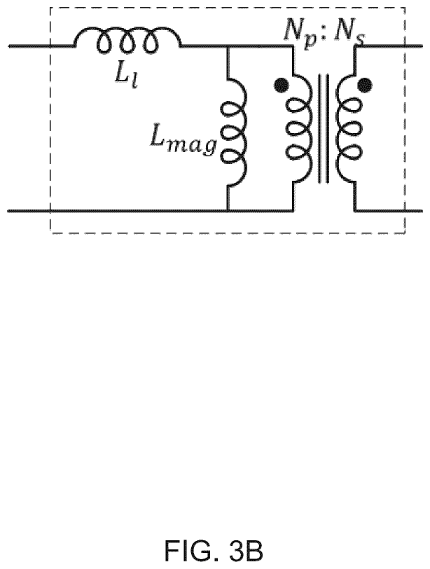

FIG. 3A is a schematic circuit diagram illustrating a galvanically isolated LCL-T resonant converter according to an embodiment of the present disclosure. In the LCL-T resonant converter, an LCL-T resonant network is connected to a full-bridge inverter from a DC source V_{IN} and is connected to a high-frequency isolation transformer. The LCL-T resonant network includes two inductors L₁ and L₂ and a capacitor Cr connected in a “T” fashion. The full-bridge inverter includes four switches Q₁, Q₂, Q₃ and Q₄. The secondary side of the transformer is rectified using a full-bridge rectifier and is connected to a load. The full-bridge rectifier includes four switches SR₁, SR₂, SR₃ and SR₄. The magnetizing inductance of the transformer may be very high, thus eliminating airgap from the transformer. In general, any inverter and rectifier structure with the LCL-T resonant network is a viable candidate for magnetic integration of transformer and inductor, where the inductor L₂ of the LCL-T resonant network is in series with the transformer having very high magnetizing inductance. This concept is further illustrated in FIG. 3B. In the most generic form, a high-frequency transformer with Nₚ:Nₛ turns ratio can be constructed to integrate an inductance Lₗ as its leakage inductance, with the constraint that the magnetizing inductance L_{mag} is much larger than the leakage inductance Lₗ(L_{mag}>>Lₗ). Of course, in addition to integrating a leakage inductor, a turns ratio of the primary turns (Nₚ) to the secondary turns (Nₛ) may be constructed for achieving specific voltage-to-voltage or current-to-current step-up or step-down functionality.

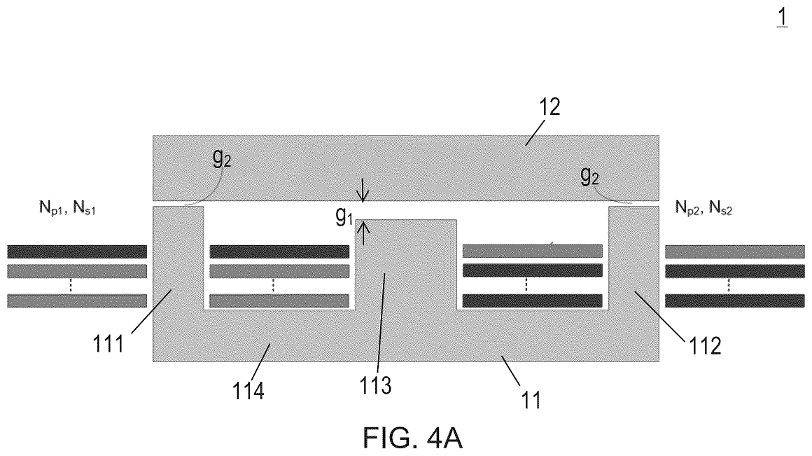

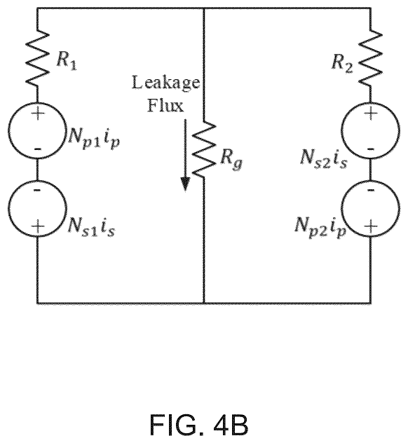

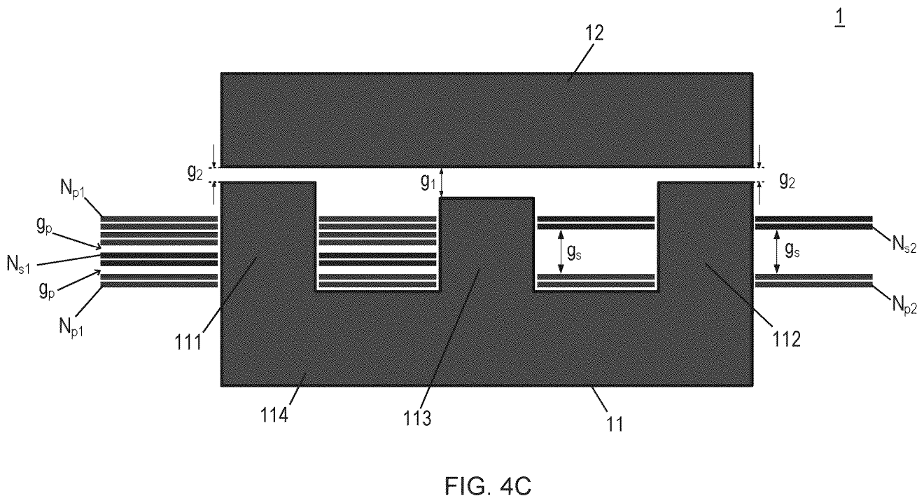

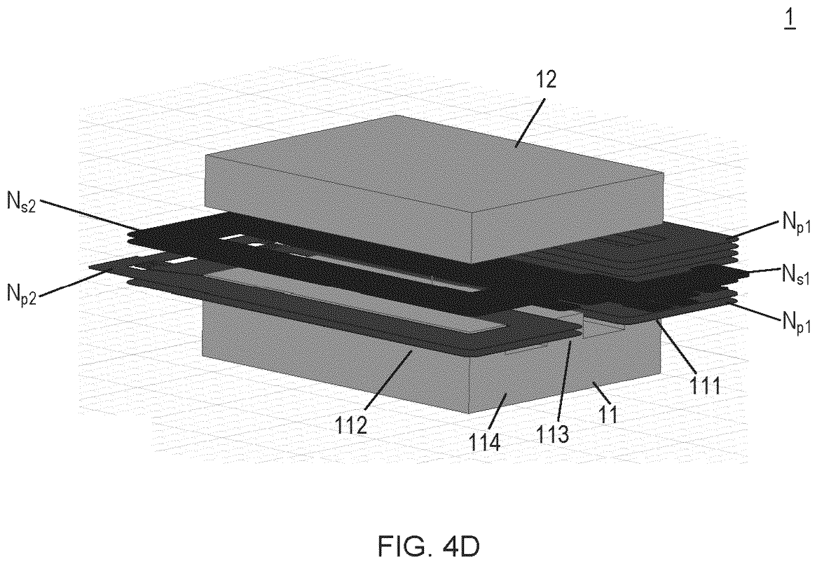

FIG. 4A is a schematic diagram illustrating a magnetic component for the galvanically isolated LCL-T resonant converter according to an embodiment of the present disclosure. As shown in FIG. 4A, the magnetic component 1 includes a first core 11, a second core 12, a primary winding, and a secondary winding. The first core 11 includes a first outer post 111, a second outer post 112, and a center post 113, and the center post 113 is disposed between the first outer post 111 and the second outer post 112. The primary winding has primary turns Nₚ including first primary turns Nₚ₁ located around the first outer post 111 and second primary turns Nₚ₂ located around the second outer post 112. The secondary winding has secondary turns Nₛ including first secondary turns Nₛ₁ located around the first outer post 111 and second secondary turns Nₛ₂ located around the second outer post 112. The center post 113 of the first core 11 and the second core 12 are separated by a first air gap g₁. In some embodiments, the first outer post 111 and the second outer post 112 of the first core 11 are separated from the second core 12 by a second air gap g₂, which is different from the first air gap g₁. Preferably, the first core 11 is an E core, and the second core 12 is an I core. In some embodiments, the first core 11 further includes a bottom plate 114 on which the first outer post 111, the second outer post 112 and the center post 113 are disposed. In some embodiments, the first outer post 111, the second outer post 112, the center post 113 and the bottom plate 114 have a same thickness.

FIG. 4B shows a reluctance model of the magnetic component of FIG. 4A. In FIG. 4B, iₚ and iₛ are the currents flowing through the primary and secondary windings respectively. As shown in FIG. 4B, it is relatively easy to see how the center post 113 of the first core 11 provides a leakage flux path for both primary and secondary windings. It is clear how some of the fluxes generated by the MMF (magnetomotive force) source Nₚ₁iₚ would not link with the second secondary turns Nₛ₂ of the secondary winding as that flux is shunted away through the reluctance R_{g}. Similar argument is valid for fluxes produced by the first secondary turns Nₛ₁ to the second primary turns Nₚ₂ and vice versa. One important factor to consider here is the fact of turns distribution. If

$${N}_{p 1} = {N}_{p 2} = \frac{{N}_{p}}{2}$$

is chosen, then although Nₚ₁ and Nₚ₂ would respectively create some leakage fluxes on their own through the center post 113, the net resultant leakage flux from the primary windings would be zero due to cancellation and end up flowing through the outer posts 111 and 112 due to the opposite direction of the leakage fluxes created by Nₚ₁ and Nₚ₂ in the center post 113. Similar argument can be made for the secondary winding with the distribution of

$${N}_{s 1} = {N}_{s 2} = \frac{{N}_{s}}{2} .$$

Hence, although the equal distribution of turns is best suited for interleaving and winding loss minimization, it may fail to generate leakage flux. To generate any controllable leakage flux, it may be important to create an unequal distribution of turns in the magnetic component 1 of FIG. 4A.

FIG. 4C exemplifies an example of an unequal distribution of turns in the magnetic component of FIG. 4A, and FIG. 4D is a schematic perspective view illustrating the example of FIG. 4C. In the embodiment shown in FIG. 4C and FIG. 4D, Nₚ₁=6, Nₛ₁=2, Nₚ₂=2, and Nₛ₁=2, where the first primary turns Nₚ₁ are split into a first part of 4 turns and a second part of 2 turns, and the first secondary turns Nₛ₁ are located between the first and second parts of the first primary turns Nₚ₁. In an embodiment, as shown in FIG. 4C, the first primary turns Nₚ₁ and the first secondary turns Nₛ₁ on the first outer post 111 are separated with a controllable gap gₚ to reduce parasitic capacitance and to minimize fringing field related eddy current losses, where the gap gₚ may be increased for reducing capacitance. In an embodiment, as shown in FIG. 4C, the second primary turns Nₚ₂ and the second secondary turns Nₛ₂ on the second outer post 112 are separated with a controllable gap gₛ to reduce parasitic capacitance and to minimize fringing field related eddy current losses, where the gap gₛ may be increased for reducing capacitance.

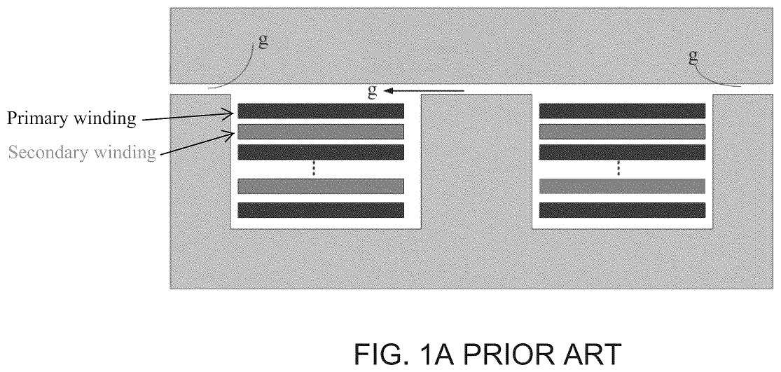

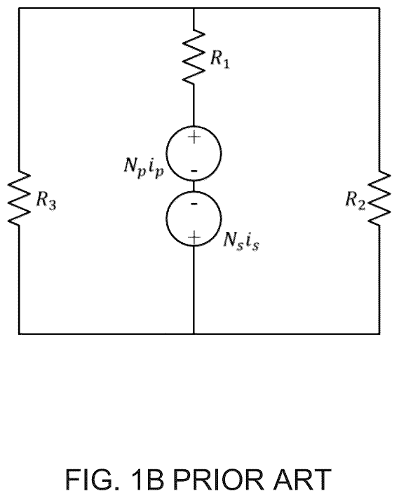

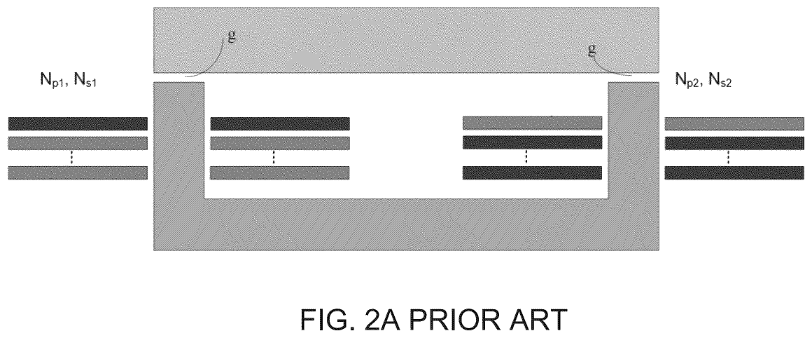

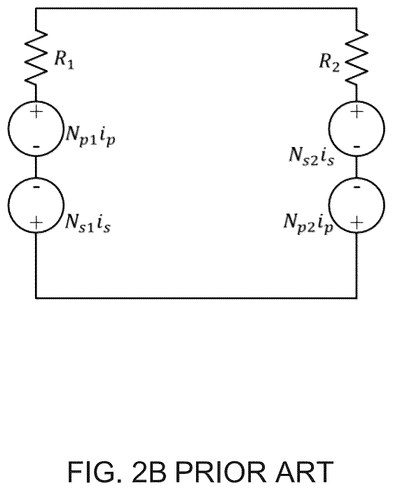

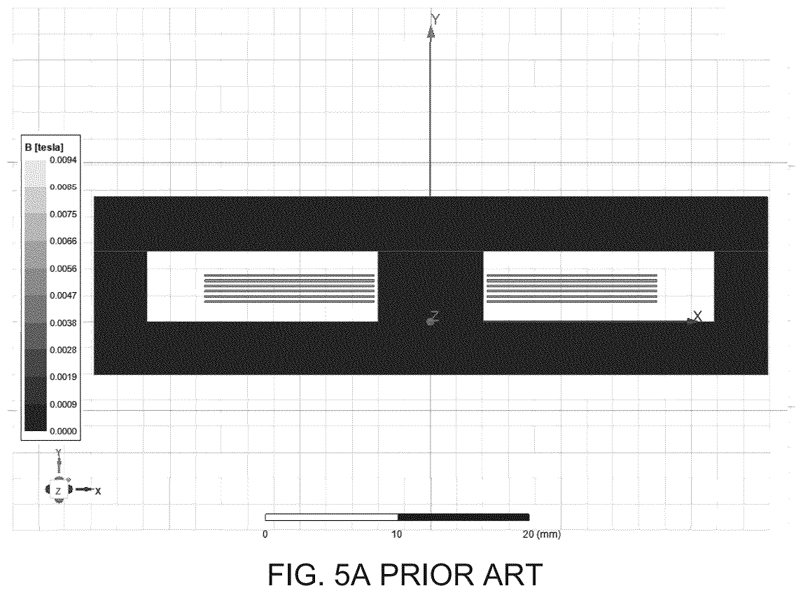

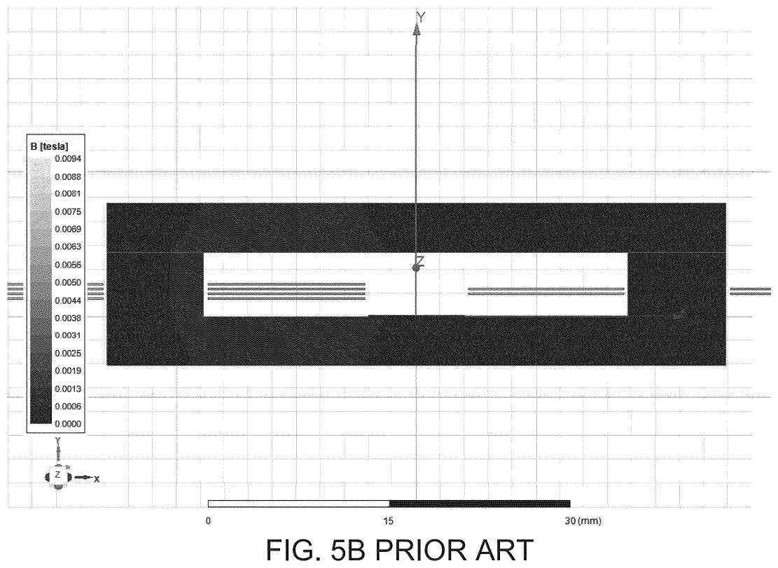

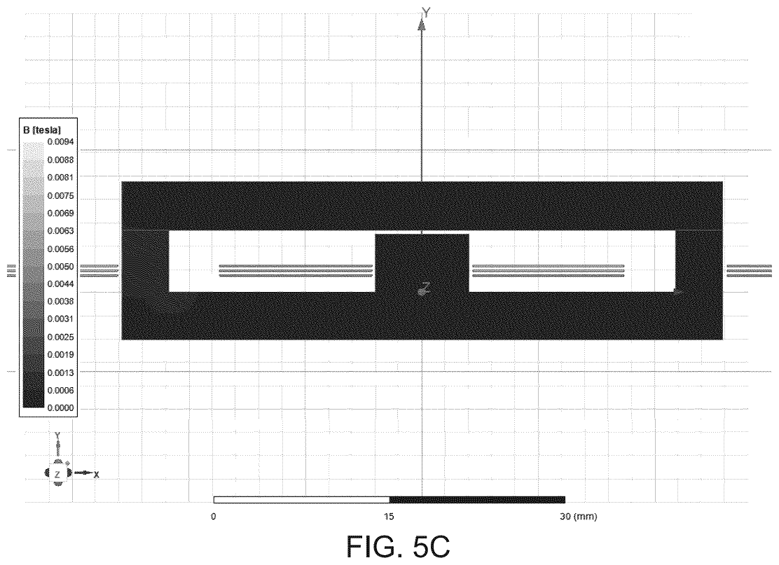

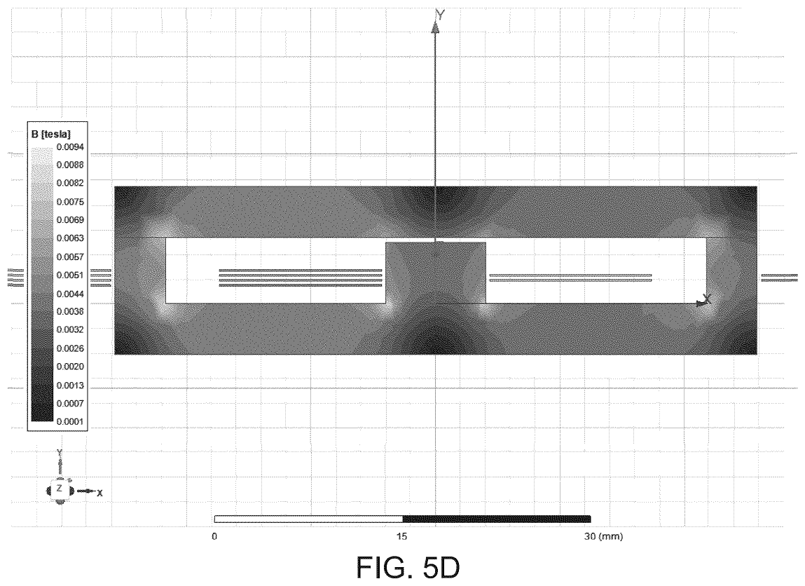

The dependency on leakage inductance to magnetic structure and turns distribution is visually demonstrated in FIG. 5A through FIG. 5D. FIG. 5A shows a 2D FEM (finite element method) simulation of the magnetic structure of FIG. 1A with fully interleaved primary and secondary windings around the center post of an E core. From the 2D FEM simulation, it is clear that this arrangement results in zero leakage flux in the core. Similarly, for the U core shown in FIG. 2A, FIG. 5B shows how even with unequal distribution of turns, no measurable leakage flux flows in the core. FIG. 5C shows a 2D FEM simulation of the magnetic component of FIG. 4A with the windings distributed equally with Nₚ₁=Nₚ₂ and Nₛ₁=Nₛ₂. This also fails to generate leakage flux due to superposition effect described earlier and leakage fluxes on the center post getting cancelled by each other. Finally, FIG. 5D shows a 2D FEM simulation of the magnetic component of FIG. 4A with unequal distribution of turns around the outer posts 111 and 112. The unequal turns distribution along with controllable first air gap g₁ are capable of generating significant leakage flux to realize the resonant inductor integration with the high-frequency transformer. In other words, the first primary turns Nₚ₁, the second primary turns Nₚ₂, the first secondary turns Nₛ₁, the second secondary turns Nₛ₂, and the first air gap g₁ are used to control and integrate a controllable leakage inductance, where the center post 113 is used as a leakage path. The magnetic component 1 magnetically integrates the transformer and the controllable leakage inductance to serve as a resonant inductor.

It is noted that many choices of Nₚ₁≠Nₚ₂ and Nₛ₁≠Nₛ₂ with the constraints of Nₚ₁+Nₚ₂=Nₚ and Nₛ₁+Nₛ₂=Nₛ can result in the required leakage inductance integration. Of course, the situation that Nₚ₁+Nₛ₁≠Nₚ₁+Nₛ₂ is also included in these choices. Among these choices, depending on the degree of interleaving and the amount of resultant flux in the core, the loss in the integrated magnetic component can vary widely. The present disclosure first points out the wide variety of choices available for the same resonant inductor integration and then lays out an optimization methodology to peak the optimized design.

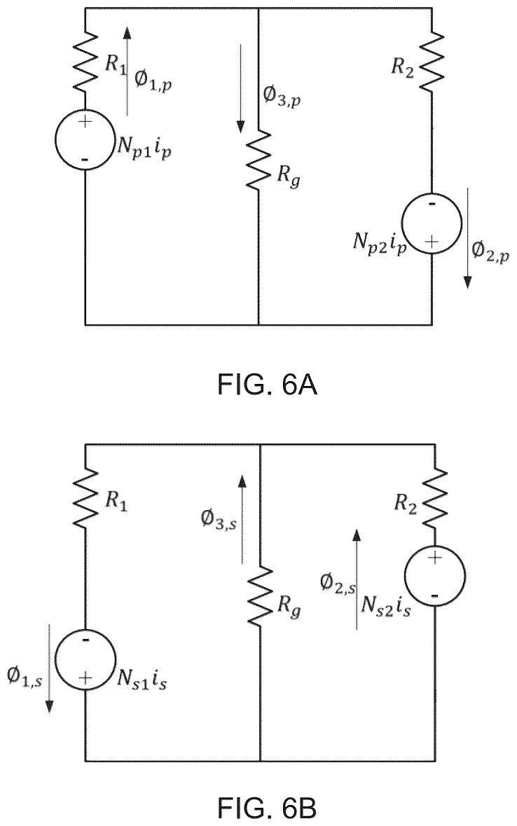

In order to optimize the turns distribution, first an analytical model may be required to determine the relation of the leakage inductance and the turns distribution. In order to do so, first the reluctance model shown in FIG. 4B may be solved by some conventional approaches. FIG. 6A shows the analysis process when the secondary winding is inactivated. Solving this circuit results in the fluxes Ø_{1,p}, Ø_{2,p} and Ø_{3,p} generated by the primary winding through the first outer post 111, the second outer post 112 and the center post 113 of the first core 11 respectively. Once these fluxes Ø_{1,p}, Ø_{2,p} and Ø_{3,p} are determined, the flux linkage for primary and secondary windings can be calculated. This circuit might also enable to directly calculate the leakage inductance generated from primary windings according to the leakage flux which does not link the secondary winding. As the first air gap g₁ on the center post 113 is longer than the second air gap g₂ on the outer posts 111 and 112, an assumption of R_{g}>>R₁, R₂ can be made, which simplifies the expressions and makes them design oriented. Here

$${R}_{g} = \frac{{g}_{1}}{{μ}_{0} {A}_{e}} ; {R}_{1} = {R}_{2} = \frac{2 {g}_{2}}{{μ}_{0} {A}_{e}} .$$

Then, the primary side leakage inductance L_{l,p} can be found as:

$$\begin{matrix}{L}_{l , p} = \frac{{N}_{p 1} {∅}_{1 , p} + {N}_{p 2} {∅}_{2 , p}}{{i}_{p}} - \frac{{N}_{s 1} {∅}_{1 , p} + {N}_{s 2} {∅}_{2 , p}}{{i}_{p}} \frac{{N}_{p 1} + {N}_{p 2}}{{N}_{s 1} + {N}_{s 2}} \\ = \frac{( {N}_{s 2} {N}_{p 1} - {N}_{s 1} {N}_{p 2} ) ( {N}_{p 1} {R}_{2} - {N}_{p 2} {R}_{1} )}{( {N}_{s 1} + {N}_{s 2} ) ( {R}_{g} {R}_{2} + {R}_{g} {R}_{1} + {R}_{1} {R}_{2} )}\end{matrix} \qquad ( 1 )$$

Similarly, solving the circuit of FIG. 6B, where the primary winding is inactivated, the secondary side leakage inductance L_{l,s} can be found as:

$$\begin{matrix}{L}_{l , s} = \frac{{N}_{s 1} {∅}_{1 , s} + {N}_{s 2} {∅}_{2 , s}}{{i}_{s}} - \frac{{N}_{p 1} {∅}_{1 , s} + {N}_{p 2} {∅}_{2 , s}}{{i}_{s}} \frac{{N}_{s 1} + {N}_{s 2}}{{N}_{p 1} + {N}_{p 2}} \\ = \frac{( {N}_{p 2} {N}_{s 1} - {N}_{p 1} {N}_{s 2} ) ( {N}_{s 1} {R}_{2} - {N}_{s 2} {R}_{1} )}{( {N}_{p 1} + {N}_{p 2} ) ( {R}_{g} {R}_{2} + {R}_{g} {R}_{1} + {R}_{1} {R}_{2} )}\end{matrix} \qquad ( 2 )$$

Using superposition theorem from the previous two equations (1) and (2), the complete leakage inductance Lₗ can be obtained as:

$${L}_{l} = {L}_{l , p} + {L}_{l , s} \frac{{( {N}_{p 1} + {N}_{p 2} )}^{2}}{{( {N}_{s 1} + {N}_{s 2} )}^{2}} = \frac{{μ}_{0} {A}_{e}}{{g}_{1}} \frac{{( {N}_{s 2} {N}_{p 1} - {N}_{p 2} {N}_{s 1} )}^{2}}{{( {N}_{s 1} + {N}_{s 2} )}^{2}} \qquad ( 3 )$$

The expression of the complete leakage inductance Lₗ shows that the complete leakage inductance Lₗ can be obtained either by controlling the first air gap g₁, or the sectional area (area of cross-section) Aₑ of the center post 113, or importantly the turns distribution around the outer posts. Furthermore, for core loss evaluation, it may be important to evaluate the flux through each post as shown in FIG. 6C. In FIG. 6C, arrow lines show the positive direction of the fluxes. From the solution using superposition described earlier, the fluxes Ø₁, Ø₂ and Ø₃ through the first outer post 111, the second outer post 112 and the center post 113 and the flux density B₃ in the center posy 113 may be found as:

$${∅}_{3} = {∅}_{3 , p} - {∅}_{3 , s} = \frac{{i}_{p}}{{R}_{g} ( {N}_{s 1} + {N}_{s 2} )} ( {N}_{s 2} {N}_{p 1} - {N}_{s 1} {N}_{p 2} ) ;$$

$$\begin{matrix}{∅}_{1} = - {∅}_{2} = \frac{{∅}_{3}}{2} & ( 4 ) \\ {B}_{3} = \frac{{∅}_{3}}{{A}_{e}} = {i}_{p} \sqrt{\frac{{L}_{l} {μ}_{0}}{{g}_{1} {A}_{e}}} & ( 5 )\end{matrix}$$

Although from Eq. (4) and Eq. (5) it is clear that having a larger Aₑ may result in smaller asymmetry in turns distribution (by virtue of lowering (Nₛ₂Nₚ₁−Nₛ₁Nₚ₂)²) and lower flux density in the post, for power dense designs the cross-sectional area cannot be made arbitrarily large. Hence, in the present embodiment, for a more practical design, a size limitation must be imposed on the magnetic structure, and then the turns distribution should be optimally picked to realize the required leakage inductance. From the solution of FIG. 6C, the magnetizing inductance L_{mag} may be found as:

$${L}_{mag} = \frac{{N}_{p}^{2}}{( {R}_{1} + {R}_{2} )} \qquad ( 6 )$$

Since for integrated transformers, generally the magnetizing inductance L_{mag} might need to be much larger than the leakage inductance Lₗ, the correlations of g₂<<g₁ and R_{g}>>R₁, R₂ remain valid. Now, for an optimal design choice with given size, different choice of turns Nₚ₁ and Nₛ₁ can result in very different losses in the integrated magnetic component 1. It should be noted that once Nₚ₁ and Nₛ₁ are picked, the turns around the other outer post 112 is automatically determined as Nₚ₂=Nₚ−Nₚ₁ and Nₛ₂=Nₛ−Nₛ₂.

When the leakage inductance Lₗ is kept the same and the area of cross-section of the posts of the first core 11 is kept constant, from Eq. (3), it is obvious that for different choice of Nₚ₁ and Nₛ₁ the airgap g₁ needs to change to maintain the same leakage inductance Lₗ. In this process, according to Eq. (5), the flux density in the core changes as well, resulting in different core losses. It could be derived that the core losses are very high when

$${N}_{p 1} = \frac{{N}_{p}}{2} and {N}_{s 1} = \frac{{N}_{s}}{2} .$$

On the contrary, for winding losses, this trend is completely opposite. When

$${N}_{p 1} = \frac{{N}_{p}}{2} and {N}_{s 1} = \frac{{N}_{s}}{2} ,$$

the flux density and core losses are very high, but the winding losses are relatively low. This is due to higher degree of achievable interleaving. When the turns are symmetrically distributed

$$( i . e . , {N}_{p 1} = \frac{{N}_{p}}{2} and {N}_{s 1} = \frac{{N}_{s}}{2} ) ,$$

good interleaving can be achieved on the first and second outer posts 111 and 112.

Therefore, for asymmetric turns distribution, where all the primary turns or secondary turns are allocated to either of the outer posts, due to severe loss of interleaving, the winding losses are very high, resulting in large total losses of the magnetic component 1. Similarly, for symmetric turns distribution, although interleaving can be better achieved, the relatively high flux densities in the posts of the first core 11 result in dominant core losses, which causes large total losses of the magnetic component 1. Consequently, the optimized turns distribution is obtained with some trade-off between core and winding losses to make a total loss of the magnetic component 1 relatively low. In other words, the first primary turns Nₚ₁, the second primary turns Nₚ₂, the first secondary turns Nₛ₁, and the second secondary turns Nₛ₂ are controlled to make a total loss, including core and winding losses, of the magnetic component 1 less than a preset value.

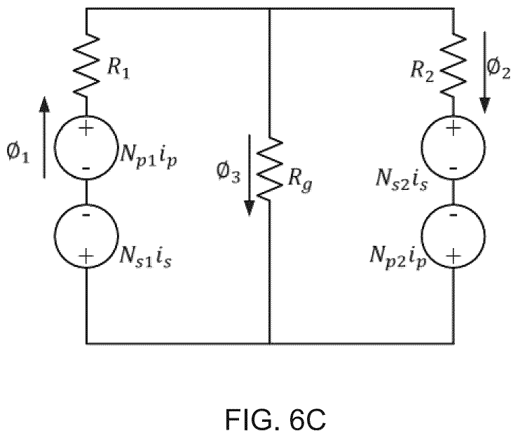

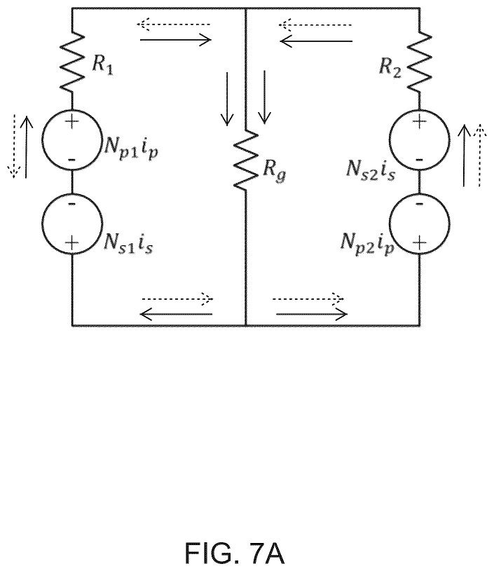

In the optimization process so far, attention has only been given to the leakage flux and inductance. The leakage flux splits equally on the two outer posts 111 and 112 as long as R₁=R₂. The magnetizing flux has a very different trend compared to the leakage flux. As indicated in FIG. 7A, the flow directions of the leakage flux and the magnetizing flux are depicted by solid arrow lines and dashed arrow lines respectively. The magnetizing flux only closes through the outer posts of the first core 11. Hence, at one outer post the leakage and magnetizing fluxes add up, whereas at the other outer post they cancel each other. The magnitude of the magnetizing flux density is given as:

$${B}_{mag} = \frac{\int {v}_{sec} dt}{{N}_{s} {A}_{e , outer}} \qquad ( 7 )$$

In the Ansys simulation shown in FIG. 7B, this effect is visible in the flux density distribution as well. In order to circumvent this issue, the present disclosure provides a modification to the first core 11. To suppress the effect of the magnetizing flux density and keep the optimization process described earlier valid—where mainly the impact of leakage flux is described, the magnetizing flux density should be kept relatively smaller compared to the leakage flux density in some embodiments.

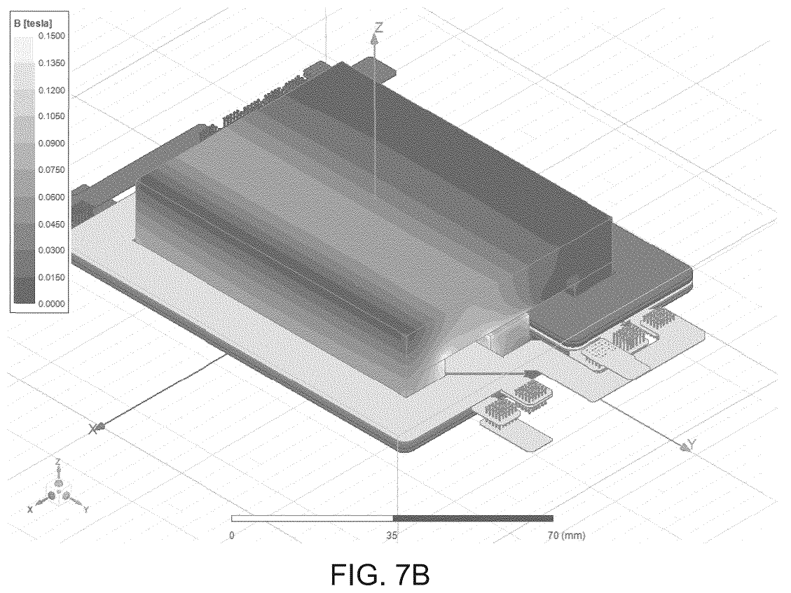

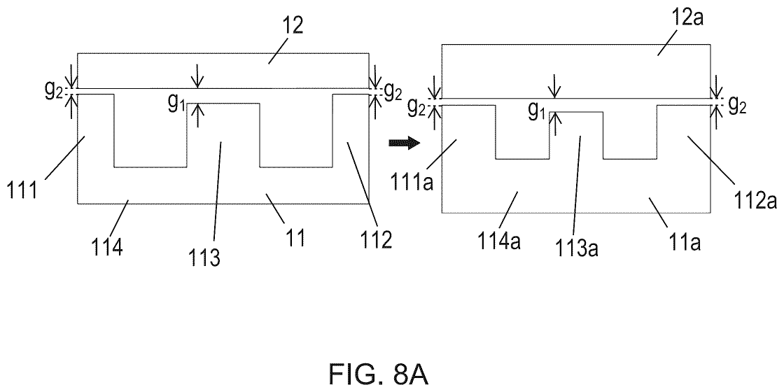

FIG. 8A shows the modification to the first core of the magnetic component. In the modified first core 11a, the first and second outer posts 111a and 112a now have the same thickness as the center post 113a, which helps in reducing the overall impact of magnetizing flux density on the outer posts 111a and 112a. This change also impacts the value of magnetizing inductance. For example, if the thickness of the center posts 113 and 113a is kept the same, the magnetizing inductance would be doubled through the modification. This impact is fine for LCL-T resonant converters where the magnetizing inductance can be very large compared to the leakage inductance. To control the magnetizing inductance, a smaller air gap might be required for the outer posts 11a and 112a as well. In other words, the second air gap g₂ may be used to control the magnetizing inductance of the magnetic component 1.

FIG. 8B exemplifies a detailed geometry of the modified cores of FIG. 8A. Here the additional height of the two outer posts marked as c+l_{g} is utilized to create the first air gap g₁. According to the marked dimensions of FIG. 8B, the sectional area for the posts may be identified as Aₑ=ab. The second core 12a has no special nature and may be constructed as a simple slab of ferrite. The thickness (marked as “h”) of the second core 12a is equal to the thickness (marked as “a”) of the posts 111a, 112a and 113a of the first core 11a and the thickness (marked as “h”) of the bottom plate 114a of the first core 11a.

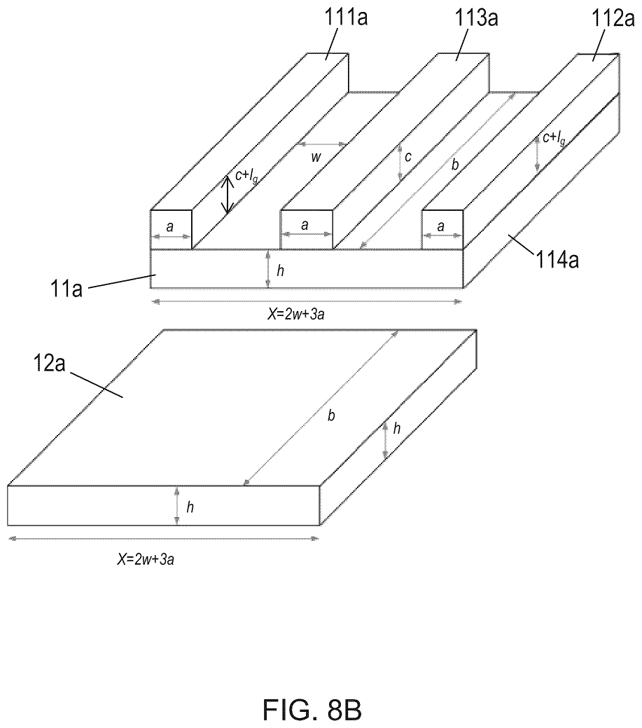

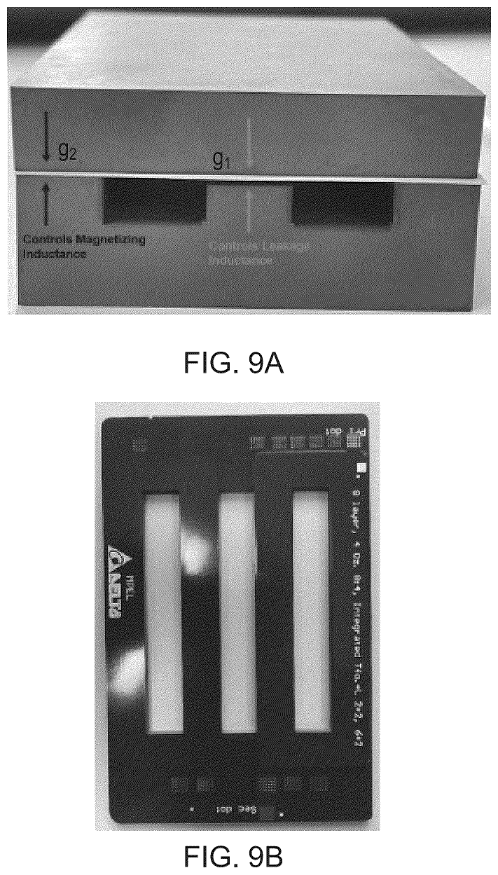

FIG. 9A exemplifies an actual implementation of the first and second core of the magnetic component. Two definite air gaps g₁ and g₂ are clearly marked here. The first air gap g₁ and the second air gap g₂ are used to control the leakage inductance and the magnetizing inductance of the magnetic component 1 respectively.

FIG. 9B exemplifies an implementation of the windings in a PCB. In the embodiment, it should be noted that the windings are closed around the two outer posts of the first core.

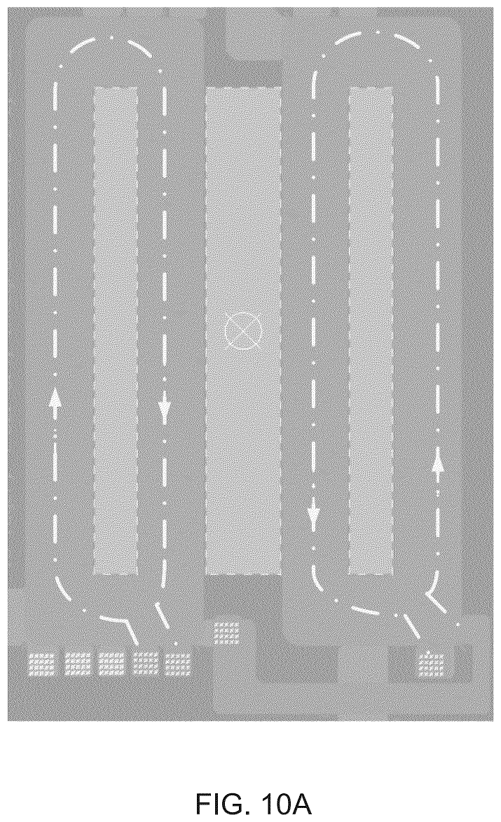

FIG. 10A elaborates on the winding arrangement. It is shown how the primary turns around one outer post of the first core need to be connected in series with the primary turns around the other outer post of the first core. In the embodiment, the direction of winding needs to be consistent with FIG. 10A in order to ensure the flux direction in the first core. Similar arguments are valid for the secondary winding as well. FIG. 10B shows how the secondary winding should be connected in the PCB to get the desired direction of flux path.

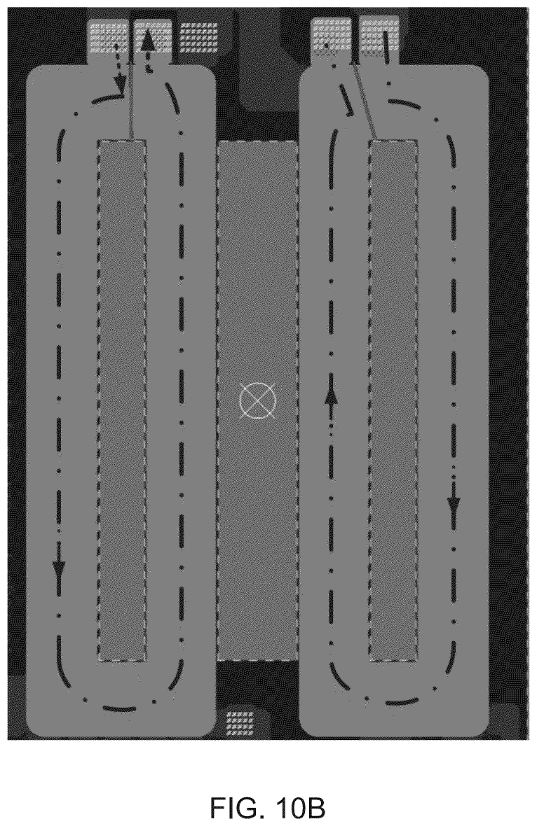

Next, a few 3D FEM simulations are presented to quantify the benefits associated with the optimization approach described in this embodiment of the present invention. In FIG. 11, the first air gap g₁ is adjusted to be very small to compensate for the symmetrical turns distribution with Nₚ₁=5, Nₛ₁=3 and Nₚ₂=3, Nₛ₂=1. From the flux density in the core, it is visible how this design would result in very high core losses, although the current density distribution in the windings is relatively uniform in this case.

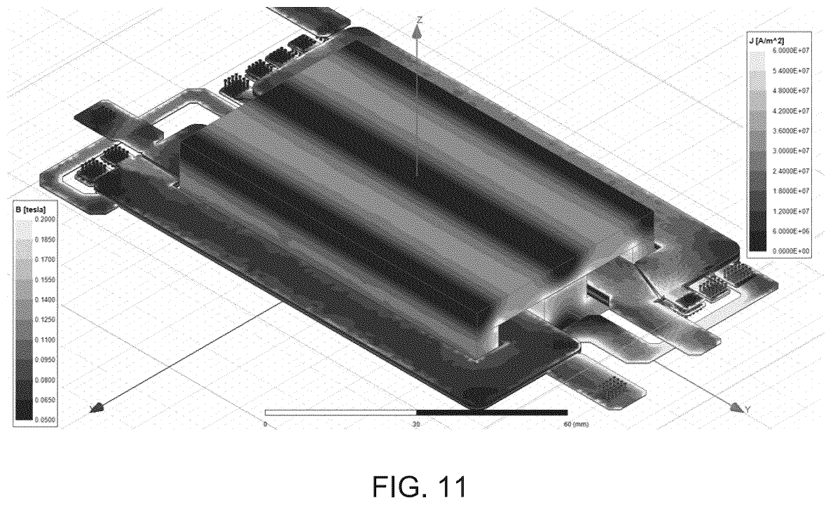

In FIG. 12, an alternate design with large asymmetry in turns distribution is shown with Nₚ₁=7, Nₛ₁=1 and Nₚ₂=1, Nₛ₂=3, which achieves the same leakage inductance as the design of FIG. 11. To compensate the leakage inductance, the first air gap g₁ is kept very high according to Eq. (3). In this case, although the flux density is very low in the core and results in very small core losses, due to loss of interleaving, the winding losses are very high, which also makes the overall loss in this design very high.

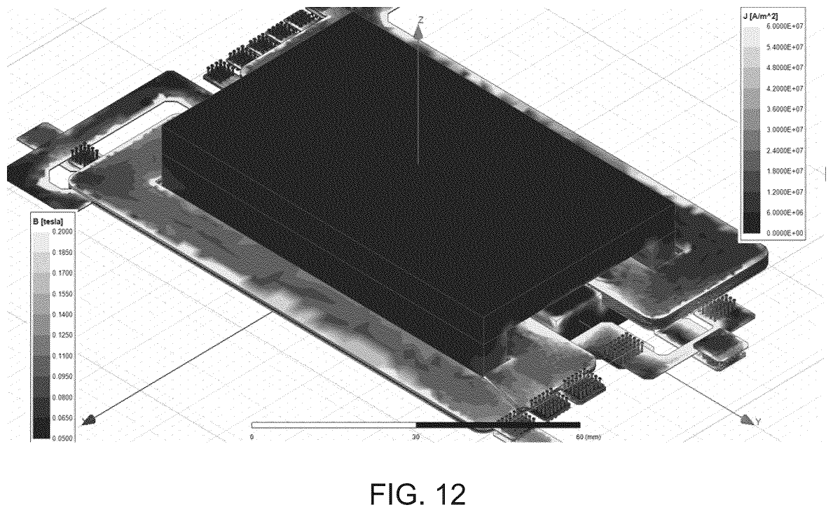

Finally, FIG. 13 shows an optimally picked design with Nₚ₁=6, Nₛ₁=2 and Nₚ₂=2, Nₛ₁=2. It is noted that both flux density and current density distribution are within reasonable limits in this case. Thus, this design would result in a good trade-off between core and winding losses and would result in minimum total loss of the magnetic component while still realizing the required leakage inductance integrated to the high-frequency transformer.

There are some applications (such as multiple port DC-DC converters) where multiple-winding transformers are required. In such transformers, often, it is desirable to control the inductances originating from each of the windings. An E+I core with controlled air gap on the center post can be used for this application as well. Also, the windings can be redistributed to the outer posts in an asymmetric way to generate controllable leakage inductance.

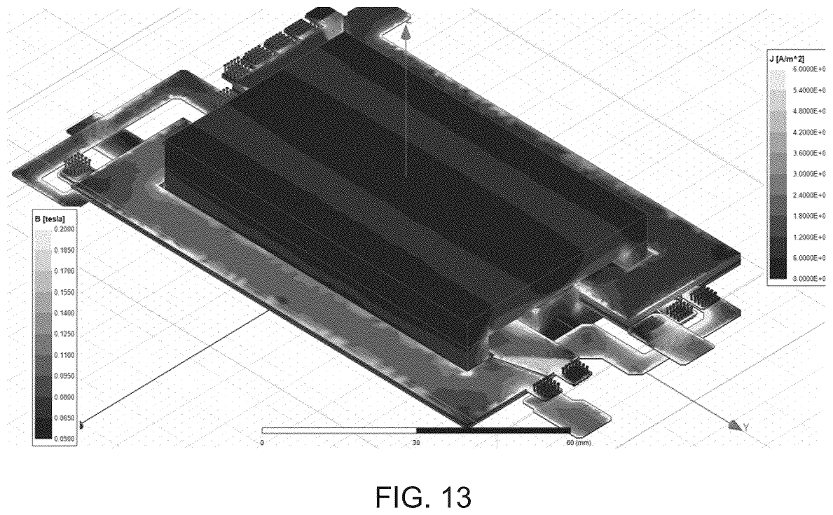

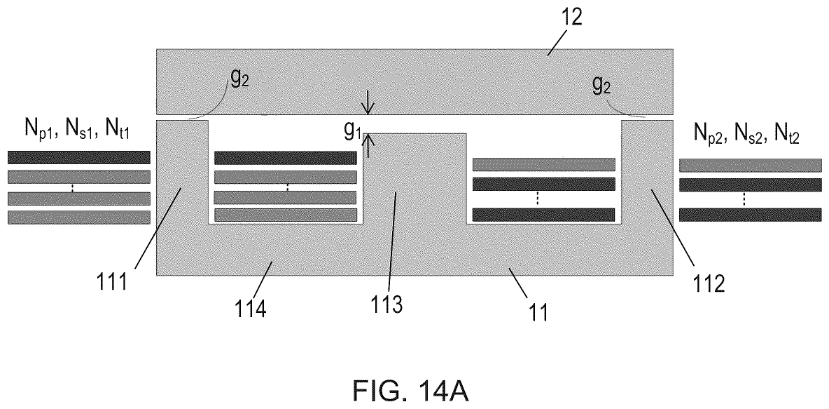

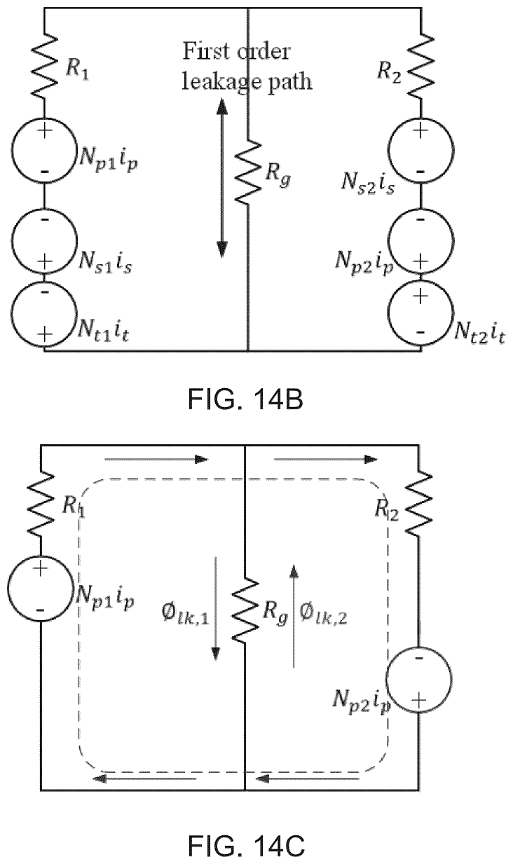

An extension of the proposed technique to multiple-winding transformer is shown in FIG. 14A. In some embodiment, as shown in FIG. 14A, the magnetic component 1 further includes a tertiary winding, the tertiary winding includes tertiary turns including first tertiary turns Nₜ₁ located around the first outer post 111 and second tertiary turns Nₜ₂ located around the second outer post 112. The first tertiary turns Nₜ₁ may be equal or unequal to the second tertiary turns Nₜ₂. In some embodiment, one of the first and second tertiary turns Nₜ₁ and Nₜ₂ may be zero. The first and second cores 11 and 12 in FIG. 14A is corresponding to those in FIG. 4A, but not limited thereto. The first and second cores in this embodiment may be modified like the first and second cores 11a and 12a shown in FIG. 8A and FIG. 8B. FIG. 14B shows a reluctance model of the magnetic component of FIG. 14A.

To make the leakage contribution from any one of the windings zero, that winding can be distributed equally, or that winding can be put around the center post 113. As exemplified in FIG. 14C, if the desired leakage from the primary winding is to be nulled, Nₚ₁=Nₚ₂ should be turns distribution. This may ensure that all the fluxes generated by the primary winding link the secondary and tertiary windings, and zero leakage flux goes through the center post 113. This concept can be expanded to any winding transformer in general.

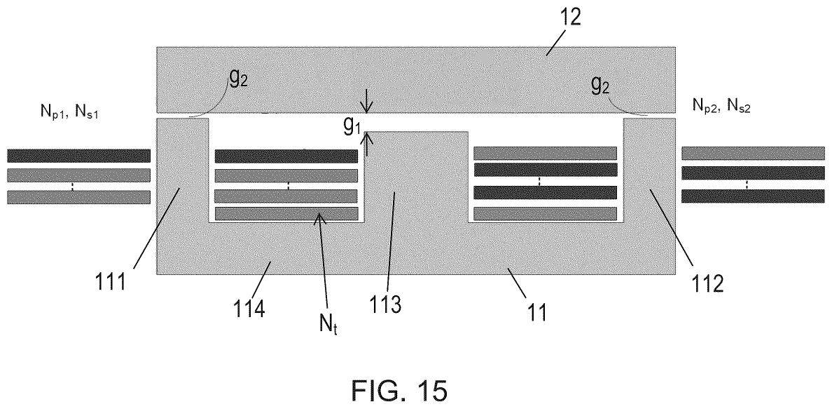

In some embodiments, as shown in FIG. 15, the tertiary turns Nₜ of the tertiary winding may be placed around the center post 113.

In some embodiments, the center post of the first core and the second core are separated by a first air gap. The number of first and second primary turns, the number of first and second secondary turns, the area of cross-section of the center post, and the first air gap are used to control and integrate a controllable leakage inductance, wherein the center post is used as a leakage path.

From the above descriptions, the present disclosure provides a magnetic component which magnetically integrates a transformer and a controllable leakage inductance to serve as a resonant inductor. The realization of this component using an optimization method is disclosed. This optimization method, utilized in conjunction with the physical arrangement shown, will result in a low loss implementation of the integrated magnetic component resulting in enhanced power density with high efficiency. The resulting component can be used in any isolated high-frequency resonant converter architecture utilizing a series resonant inductor with the transformer.

While the disclosure has been described in terms of what is presently considered to be the most practical and preferred embodiments, it is to be understood that the disclosure needs not be limited to the disclosed embodiment.

What is claimed is:

1. A magnetic component for a galvanically isolated LCL-T resonant converter, comprising:
a first core comprising a first outer post, a second outer post, and a center post disposed between the first and second outer posts;
a second core;
a primary winding with primary turns comprising first primary turns located around the first outer post and second primary turns located around the second outer post; and
a secondary winding with secondary turns comprising first secondary turns located around the first outer post and second secondary turns located around the second outer post,
wherein the first and second primary turns are unequal, and/or the first and second secondary turns are unequal,
wherein the center post of the first core and the second core are separated by a first air gap, and the first and second primary turns, the first and second secondary turns, and the first air gap are used to control and integrate a controllable leakage inductance, wherein the center post is used as a leakage path.

2. The magnetic component according to claim 1, wherein all the cores and windings form a transformer, and the magnetic component magnetically integrates the transformer and the controllable leakage inductance to serve as a resonant inductor.

3. The magnetic component according to claim 1, wherein a sum of the first primary and secondary turns is unequal to a sum of the second primary and secondary turns.

4. The magnetic component according to claim 1, wherein the first and second outer posts of the first core are separated from the second core by a second air gap, and the second air gap is used to control a magnetizing inductance of the magnetic component.

5. The magnetic component according to claim 4, wherein the magnetizing inductance is greater than the controllable leakage inductance.

6. The magnetic component according to claim 1, wherein the first and second primary turns and the first and second secondary turns are controlled to make a total loss, comprising a core loss and a winding loss, of the magnetic component less than a preset value.

7. The magnetic component according to claim 1, wherein the first primary turns and the first secondary turns on the first outer post are separated with a controllable gap to reduce parasitic capacitance and to minimize fringing field related eddy current losses.

8. The magnetic component according to claim 1, wherein the second primary turns and the second secondary turns on the second outer post are separated with a controllable gap to reduce parasitic capacitance and to minimize fringing field related eddy current losses.

9. The magnetic component according to claim 1, further comprising a tertiary winding with tertiary turns comprising first tertiary turns located around the first outer post and second tertiary turns located around the second outer post.

10. The magnetic component according to claim 9, wherein the first tertiary turns are unequal to the second tertiary turns.

11. The magnetic component according to claim 1, further comprising a tertiary winding wound around the center post.

12. The magnetic component according to claim 1, wherein the first core further comprises a bottom plate on which the first outer post, the second outer post, and the center post are disposed, and the first outer post, the second outer post, the center post and the bottom plate have a same thickness.

13. The magnetic component according to claim 12, wherein a thickness of the second core is equal to the thickness of the first outer post, the second outer post, the center post and the bottom plate of the first core.
